(19) United States
(12) Patent Application Publication
(10) Pub. No.: US 2019/0283985 A1
(43) Pub. Date: Sep. 19, 2019

(54) DEVICE FOR HANDLING PRODUCTS

(71) Applicant: GEBO PACKAGING SOLUTIONS FRANCE, REICHSTETT (FR)

(72) Inventor: Jean-Claude WAELDIN, REICHSTETT (FR)

(21) Appl. No.: 16/346,621

(22) PCT Filed: Oct. 31, 2017
(86) PCT No.: PCT/FR2017/052995

§ 371 Date: May 1, 2019

(30) Foreign Application Priority Data
Nov. 2, 2016 (FR) 1660596

(51) Int. Cl. B65G 65/00; B23Q 7/14

(52) U.S. Cl. CPC B65G 65/005; B66F 9/063; B23Q 7/1442

(57) ABSTRACT

Disclosed is a device for handling products between a workstation and another station having a collecting surface, having at least two mobile tables that are each provided with a receiving surface, the at least two mobile tables being configured to be able to be disposed side by side, adjacent to the collecting surface, so as to be able to transfer products at the same time between the at least two tables and the collecting surface. Also disclosed is a method for handling products between a workstation and another station by the disclosed device.

### BACKGROUND OF THE INVENTION

### Field of the Invention

This invention falls within the field of equipment for the conveying of products within an industrial processing line. It relates more particularly to a device for handling products between one workstation and another station.

### Description of the Related Art

In the field of the invention, a line for processing products generally comprises a group of successive stations, which transform the product until finally obtaining a pallet comprising a stacking of layers each comprising products, sometimes grouped in packs, boxes, bundles, or the like. Downstream from the line, the full pallet is then processed for shipping, optionally by passing through a facility for logistics management, particularly of the automatic storage type. The lines for processing products covered by the invention therefore perform at least one secondary packaging operation as a result of which the products one at a time are prepared for shipping in large numbers. The line can also have upstream operations, such as preparing, producing, manufacturing, storing, of the product itself, upstream from such a secondary packaging for shipping purposes.

A great quantity of identical successive products is therefore processed similarly within successive stations of the line. The line therefore ensures substantially continuously the same processing for the successive products, and this at an overall rate that defines the efficiency of the line.

This type of line is therefore necessarily equipped with means for moving the products between the stations. Traditionally, it involves mechanical conveyors of the endless-belt type, capable of rotating continuously and on which the products rest by their lower part to be carried by it between its two ends. Appropriate accumulation solutions also make it possible to provide a buffer between the successive stations.

A conveying solution for a processing line with an accumulation between two stations for processing products one at a time is, for example, proposed in the document EP1497208 and is based on the succession of a module that transforms a single-line flow into a multi-line flow, an accumulation module of such a multi-line flow, then a module for transforming the multi-line flow into a single-line flow.

Another solution for movement between two stations for processing one at a time is proposed in the document FR2998282 and is based essentially on a mechanical endless-belt conveyance, a solution for transfer to a stationary accumulation table, for a solution for transfer from said table to another endless-belt mechanical conveyor.

However, there has been a change in the use of such packaging lines for quantities of increasingly smaller identical products. The sizes of products processed are therefore changing increasingly frequently, and the changes and reconfigurations necessary for the line are then themselves also increasingly frequent. Further, the changing of size may not only require a new adjustment of the stations of the line, but also the substitution of certain stations from the line to others, compatible with the new product processed. This reconfiguration of the line in the area of the pieces of equipment that make it up is also brought about by the normal evolving of the line, to add new machines to it, to replace certain others, etc.

It is therefore increasingly important to be able to have a packaging line, upstream from the logistics installation for processing full pallets, which are the most flexible possible, capable of being adapted very quickly to new sizes of products and that it is also very easy to change to new configurations. The line must also, preferably, ensure such a flexibility and adaptability in the least expensive way possible.

### SUMMARY OF THE INVENTION

The inventor first of all conceived of substituting the stationary mechanical conveyors with autonomous movable carts, which then perform this function of relocating the products between the machines within the line. The machines, or processing stations, can therefore be stationary and positioned at various locations in the workspace, and even repositioned, or even added, or even eliminated, without having to reconsider the design of the stationary mechanical conveying solutions. To add a processing station into the line then necessitates optionally only that it be taken into consideration in the programming of the carts.

However, the time for transferring the products from the carts to the machines can be rather long, which makes it necessary to have a large number of carts. However, their capacity for autonomous relocation makes them rather expensive.

In addition, the output flow of products from certain machines is high, which leads to requiring large, rather cumbersome, carts, which makes controlling the movements of these carts difficult in the middle of a production workspace all while avoiding collisions.

This invention has as its object to eliminate at least in part these drawbacks by proposing an accumulation surface facing which are found simultaneously several autonomous tables of smaller dimensions, one behind the other, and which can, one at a time and as needed, be relocated by a single motorized cart.

For this purpose, the invention proposes a device for handling products between one workstation and another station having an accumulation surface, characterized in that it has at least two movable tables each equipped with a receiving surface, said at least two movable tables being configured so as to be able to be placed side by side, adjacent to said accumulation surface, so as to be able to transfer products at the same time between the at least two tables and the accumulation surface.

As a result of these arrangements, the movable tables are smaller than the accumulation surface and can therefore be relocated more easily in a cluttered environment.

According to other characteristics:
Said at least two movable tables can be configured to be each relocatable by an autonomous shuttle, again improving the flexibility of the device,
said device can have a means for translating a table along the accumulation surface, making it possible to perform translations at the same time as relocations, and to save time,
said translation means can be positioned integrally with the accumulation surface and can have a drive means that is movable along the accumulation surface, making it possible to perform the translations in the absence of the autonomous shuttle,
said device can have an open space for at least one table upstream and/or downstream from said at least two tables, this making it possible to place tables in standby position before and/or after having been loaded or unloaded, and to reduce the cycle times,
said device can have a means for coupling one table to another; thus, a table can be secured to at least one other and can pull it or push it; the action on a single table can therefore carry out the translation of an entire string of tables.

This invention also relates to a method for handling products between a workstation and another station, by means of a device according to the invention, and having the following steps:
Transfer of products between said at least two tables and the accumulation surface,
relocation of a first of said at least two tables,
then, relocation of a second of said at least two tables.

As a result of these arrangements, the movable tables are smaller than the accumulation surface, and can therefore be relocated more easily in a cluttered environment.

According to other characteristics:
Said method can have, before the relocation of the second of said at least two tables, the following additional step:
   depositing of an additional table in the extension of said at least two tables, so as to form with the latter an assembly similar to that of the first two tables,

thus, cycle time will be able to be saved by a grouped translation of tables,
said additional step can be performed after the relocation of the first table, so that no open space is used in the extension of said at least two tables; thus, floor space that is used is saved,
said relocation of the tables can be done by means of a single shuttle, making it possible to reduce the overall investment,
simultaneous translations of tables can be done by translation of one table pulling at least one other table, making possible a savings in cycle time.

### BRIEF DESCRIPTION OF THE DRAWINGS

This invention will be better understood upon reading the detailed description that follows, with reference to the accompanying figures in which:

FIG. 1 is a side view of a handling device according to an embodiment of the invention.

FIG. 2 is a diagrammatic view in sequence of a method according to a first embodiment of the invention.

FIG. 3 is a diagrammatic view in sequence of a method according to a second embodiment of the invention.

FIG. 4 is a diagrammatic view in sequence of a method according to a third embodiment of the invention.

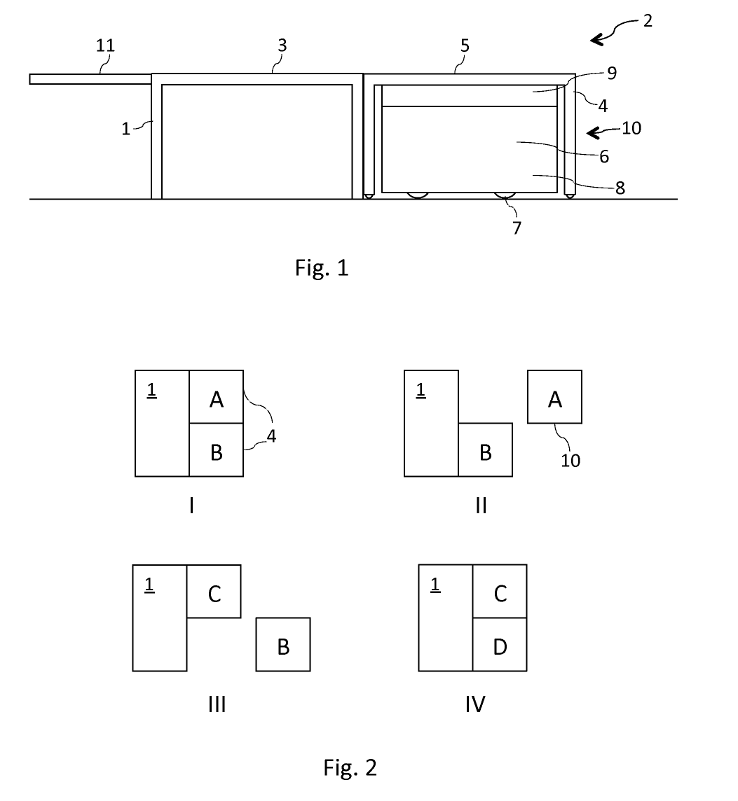

### DESCRIPTION OF THE PREFERRED EMBODIMENTS

The invention has as its object a line for processing products having a workstation 1 and a handling device 2. The handling device 2 makes it possible to transport the products between the station 1 and another station of the line for processing products.

The handling device 2 has an accumulation surface 3 located in the area of the workstation 1 and making it possible to receive products on standby during the phases for conveying between the station 1 and another station of the processing line.

The handling device 2 has at least two movable tables 4 each equipped with a receiving surface 5 on which products can be placed.

When the two tables 4 are in place against the accumulation surface 3, the products can be transferred from the station 1 to the tables 4 or vice versa. In a preferred embodiment of the invention, the receiving surfaces 5 of the tables 4 can be flush with the accumulation surface 3, which makes it possible to transfer the products from the accumulation surface 3 to the tables 4 by a transfer means that is a simple lateral push means, where necessary a means configured to push one row of products at a time, thus making it possible to transfer non-staggered products, while maintaining their non-staggered layout after the transfer. The push means can, of course, also be configured to push a portion of a row. Such a transfer means can, for example, be part of the station 1 or of each table 4.

The accumulation surface is supplied by a conveyor 11, bringing the processed products from a station for processing the products, or removing the products received onto the accumulation surface 3 bound for the next station. The station 1 also has a means for transferring the products between the conveyor 11 and the accumulation surface 3. This means is preferably a push means, and the accumulation surface 3 is placed adjacent and flush with the conveyor 11. The accumulation surface 3 can have a means for transporting in the direction of the output, either the tables 4 or the conveyor 11, for example a wide transverse conveyor, to bring the products to the edge of the accumulation surface 3, against which the tables 4 or the conveyor 11 are located, from the other side. When the tables 4 are full and must be relocated, the accumulation surface 3 provides a buffer, so that the station 1 can continue its activity and deliver products by the conveyor 11, until the placement of other tables 4, which are empty, and which will be able to be filled in turn. The buffering function is also used when, conversely, the tables 4 are used to bring products to be processed.

The conveyor 11 can also transport the products to a station for processing products, the latter being brought by the tables 4, then transferred onto the accumulation surface 3. Here again, when the tables 4 are empty and must be replaced, the products accumulated on the accumulation surface 3 are sufficiently numerous to supply the conveyor 11 until the arrival of other full tables 4.

To relocate a table 4 between the station 1 and another station, the handling device 2 can have a shuttle 6. The shuttle 6 can have wheels 7, for example four multi-directional wheels 7. It can have a frame 8 placed on said wheels 7, and a lift 9 that is movable in vertical translation in relation to the frame 8. When the lift 9 is in the low position, the shuttle 6 can be placed under the table 4. It is then possible to raise the lift 9. The shuttle 6 is engaged with the table 4 and lifts it. A cart 10 is then formed, consisting of the shuttle 6 and the table 4 made integral with them. The cart 10 can then be relocated between the station 1 and another station.

The tables 4 are movable in an autonomous way, for example by being equipped with wheels 7. This makes possible a translation of one or more tables 4, for example along the accumulation surface 3. Such a translation can be performed by a translation means, for example by providing that a cart 10 pull or push several tables 4 at a time, the latter being connected to one another.

In a particular embodiment of the invention, the translation means is integral with the accumulation surface 3 located in the area of the station 1 and makes it possible for the tables 4 to be relocated along the accumulation surface 3. The translation means can, for example, have a drive means that is movable in translation along the accumulation surface, in particular along the edge of the accumulation surface opposite to the one where the conveyor 11 circulates.

The tables 4 can be hooked to one another to form a string of tables 4; it is enough that one translation means translates a table 4, to move the entire string of tables 4.

For the sake of clarity, the word relocate or relocation will be used in this application for the movements of a cart 10 (shuttle 6 and table 4) between a workstation 1 and another station, the word translate or translation for the autonomous movements of the tables 4 along the accumulation surface 3, and the word transfer or to transfer for the movement of the products between the accumulation surface 3 and a table or tables 4.

The handling device 2 can also have a hooking means, making it possible to attach at least two tables 4 so that one of the tables 4 can pull the other during a shared translation movement. The coupling means can be a simple hook integrated into the first table 4, working with a ring integrated into the second table 4 or other mechanical engagements, or even magnetic engagements, etc. This coupling means temporarily secures at least two tables 4 to one to another and in a controlled way. It is then enough for the shuttle 6 to drive one of the tables 4, particularly in a translation movement along the edge of the accumulation surface 3, so that the other follows the same movement. It then contributes simultaneously to the switching of several tables, and this with a single motorized element, or shuttle 6, which is therefore economical.

A preferred embodiment of the invention is illustrated in FIG. 2.

According to this method, when the tables 4A and 4B are to be replaced, the first step is to relocate only the table 4A with a shuttle, and the next step is to relocate only the table 4B with the same shuttle. This method has the advantage of making possible the relocation of tables 4 that are smaller than the accumulation surface 3. It is then possible either to bring a table 4C before taking away the table 4B, or else first taking away the two tables 4A and 4B one after the other, then bringing in the tables 4C and 4D one after the other. This embodiment can be used even if there is no space available in the extension of the tables 4A and 4B beyond the length of the accumulation surface 3.

The tables 4 are located one after the other, adjacent to the accumulation surface 3, on the side opposite that of the accumulation surface where the conveyor 11 circulates. The direction of one table to the next is therefore parallel to the direction of the conveyor 11 and therefore of the edges of the accumulation surface.

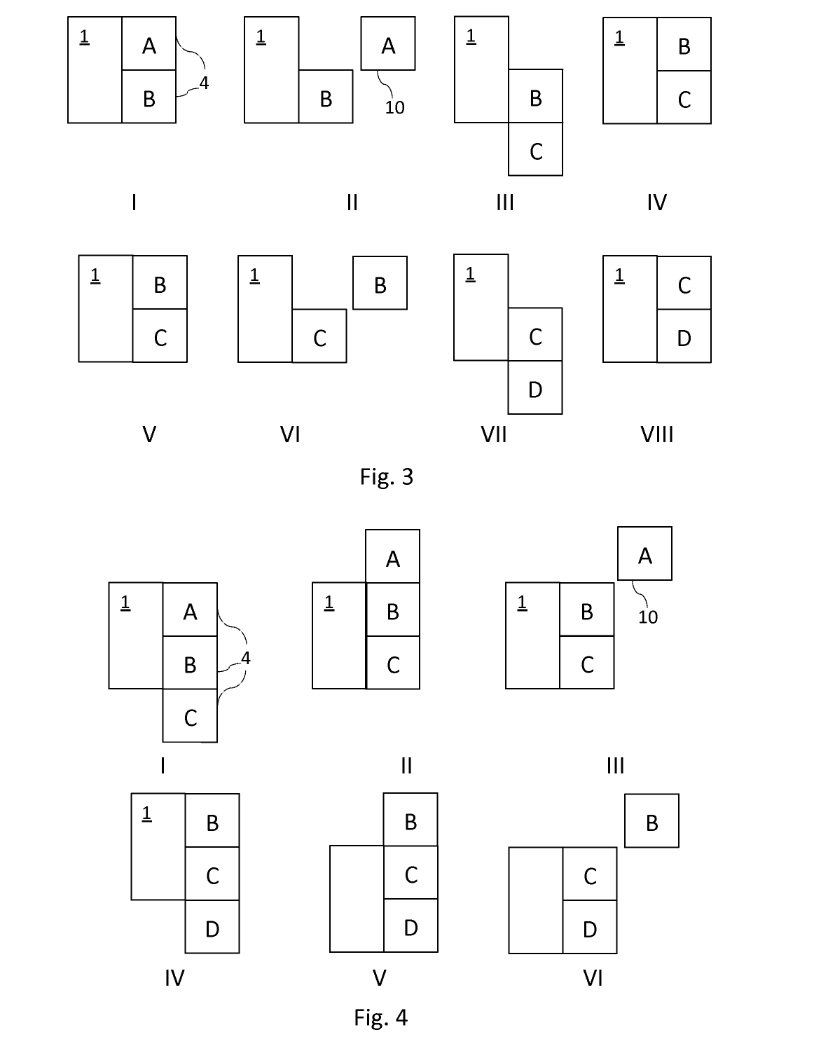

The method according to FIG. 3 makes it possible, according to a second embodiment, to transport products from a station 1 to another station:
the products are present on the accumulation surface 3, ready to be transferred to a table 4A and a table 4B; an empty additional table 4C is found just upstream from the table 4B,
once the tables 4A and 4B are filled, the shuttle 6 goes under the table 4A, raises the lift 9 and forms a cart 10 with the table 4A. The cart 10 moves away toward another station. Once the cart 10 has arrived at its destination, the shuttle 6 disengages from the table 4A and goes back to the station 1,
during this time, a translation means carries out the translation of the tables 4B and 4C to the position initially occupied by the tables 4A and 4B. By way of example, the shuttle 6 goes under the table 4B, raises the lift 9 and forms a cart 10 with the table 4B. The table 4C is hooked to the table 4B, in order to be translated with it. The cart 10 is relocated so as to pull the table 4C, and to place the tables 4B and 4C in the position initially occupied by the tables 4A and 4B. It is possible to foresee a temporary hooking of the tables 4 to one another during the translation.
The table 4B, after having formed a cart 10, is relocated to its destination station; the shuttle 6 disengages from the table 4B and goes back to the station 1,
the shuttle 6 is going to be placed under a table 4D, so as to form a cart 10. The table 4D can be the table 4A if it is again available, or a new table 4. The cart 10 is relocated to the station 1, so as to place the table 4D in the position that was initially that of the table 4C. The translation means then proceeds to place the tables 4C and 4D in the position initially occupied by the tables 4A and 4B.
the tables 4C and 4D are ready to be loaded; the situation is then identical to the initial situation.

The expression “upstream” used for the location of the table 4C in step III of FIG. 3 is used in the sense of the translation of the tables 4 along the corresponding edge of the accumulation surface. The table 4D, in step VII, is thus located upstream from the table 4C, and the table 4C is downstream from the table 4D.

To reduce the standby time for the transfer of the products from the accumulation surface 3, it is possible to move the table 4B to an interim location near the station 1 and to use the shuttle 6 to place a table 4D that is already ready upstream from the table 4C. Then, the shuttle 6 goes back to take the table 4B to move it to its destination station, while the transfer from the accumulation surface 3 to the tables 4C and 4D can already begin.

One of the advantages of the method of FIG. 3 is that it makes it possible to use only two different tables 4 for the movement of the products from the station 1 to another station, if the offloading of the table 4A downstream is going fast enough for the time allowed by the buffer consisting of the accumulation surface 3. The table 4A can then be used again as table 4C, and the table 4B can be used again as table 4D.

Furthermore, this method makes it possible to use only three different tables 4 for the movement of the products from the station 1 to another station, even if the offloading from the table 4 to the other station takes a little more time. The table 4A can then be used again as table 4D. Moreover, in the method of FIG. 2, the means of translation never translates more than two tables 4 at a time, and if said translation means has the shuttle 6, the power required for the shuttle 6 is therefore less.

This embodiment makes it possible to use table 4A, step I, even if there is not space available downstream. To do this, it is enough that the movement of the table 4A begins with a movement away from the accumulation surface 3, transverse in relation to the movement of translation of the tables 4.

However, when such a space is available, at least over the length of a table 4, it is possible to use a third embodiment of the invention, illustrated in FIG. 4. The method thus makes it possible to move products from a station 1 to another station according to the following steps:
the products are present on the accumulation surface 3, ready to be transferred to a table 4A and a table 4B, and an empty table 4C is found just after the table 4B,
once the tables 4A and 4B are filled, the shuttle 6 goes under the table 4A, raises the lift 9 and forms a cart 10 with the table 4A. The cart 10 then pulls the tables 4B and 4C to translate them to the position initially occupied by the tables 4A and 4B. The translation can be carried out by any other translation means.
The cart 10 then relocates to another station. Once the cart 10 has arrived at its destination, the shuttle 6 disengages from the table 4A and goes back to the station 1,
during this time, a translation means carries out the translation of the tables 4B and 4C to the position initially occupied by the tables 4A and 4B. By way of example, the shuttle 6 is going to be placed under a table 4D, so as to form a cart 10. The table 4D can be the table 4A if it is again available, or a new table 4. The cart 10 relocates to the station 1, so as to place the table 4D in the position that was initially that of the table 4C. The cart 10 then pushes the tables 4B and 4C to translate them to the position initially occupied by the tables 4A and 4B. It is possible to foresee a temporary hooking of the tables 4 to one another during the translation. The shuttle 6 then disengages from the table 4D,
the tables 4C and 4D are ready to be loaded; the situation is then identical to the initial situation.
the shuttle 6 goes back under the table 4B, raises the lift 9, and forms a cart 10 with the table 4B. The cart 10 then moves away toward the downstream station. Once the cart 10 has arrived at its destination, the shuttle 6 disengages from the table 4B and goes back to the station 1.

In this embodiment, the entire relocation of the table 4B could also take place concurrently, and the transfer of the products can then recommence prior to this relocation.

One advantage of the method of FIG. 3 is that it makes it possible to recommence earlier the transfer of the products between the tables and the workstation.

Depending on the offloading speed of the table 4A, it can also be used as table 4D, which makes it possible to use only three tables 4.

The above description is given with a loading of the tables 4, but the same methods can also be used for the offloading of the tables 4.

The handling device 2 can have more than two tables 4 to place along the accumulation surface 3.

When there are two tables 4, their length is approximately half of the length of the accumulation surface 3. This already has the significant advantage of making possible movements with tables 4 that are two times smaller than with the state of the art. Furthermore, the space to be provided for an additional table 4 upstream and/or downstream from the tables 4 that are at the same time working with the accumulation surface 3 is also smaller.

When there are three tables 4, their length is approximately a third of the length of the accumulation surface 3. This makes it possible to have still smaller tables 4 and open spaces.

Of course, it is also possible to have four or five tables 4 or more. The tables 4 are smaller, or else they make possible the transfer of products from larger accumulation surfaces 3.

However, the more tables 4 there are, the more relocations will be needed.

Generally, the group of the tables 4 facing the accumulation surface has a dimension, along the edge of said surface that extends parallel to the conveyor 11, which makes it possible for said group to ensure the transfer of an entire batch of products, namely a batch of one or more columns extending all along said edge.

One advantage of this invention consists in the possibility of choosing the number of tables 4, according to the size of the accumulation surface 3, the distance of the relocations, the space between the workstations. It is then possible to find an optimum, which makes possible, on the one hand, a downtime for the transfer of the products consistent with the size of the accumulation surface 3 and the processing rate of the products, then a footprint on the ground that is the smallest possible for the position of the active tables 4 for the transfer, and of the additional tables 4, and finally a size of carts 10 being relocated that is the smallest possible.

Thus, in accordance with what has just been described, it will be noted that the movable tables 4 preferably lack a motorized element, but it is a motorized shuttle that is used to ensure the relocations of the table 4, between two stations or else against the accumulation surface, if applicable. Preferably, a single motorized shuttle is used for all of the relocations of all of the tables 4. Either the shuttle drives each table separately, or at least the one of them which is attached to another [table] is relocated directly by the shuttle.

In position for a transfer of products, either from the accumulation surface 3 or to the surface, the at least two tables 4 are one in the extension of the other along the accumulation surface 3. The latter has two edges, the conveyor 11 circulating against one of them, and the at least two tables 4 being against the opposite edge. Of course, the tables 4 are stationary during the transfer of the products. They are therefore one after the other in the direction of the conveyor 11.

The device is thus equipped with a transfer means that acts in a cyclical manner to transfer, at each cycle, by flat horizontal sweeping, a batch of products from the accumulation surface 3 to the tables or vice versa, this batch extending essentially over the entire length of the accumulation surface 3 perpendicular to the direction of the transfer, parallel to the direction of the conveyor 11.

The switching of the group of tables 4 together forming the surface to the right of the accumulation surface is therefore accomplished by the successive performing of a switching method for each of the tables. So as to reduce the time required, it is then preferred that the switching method for one of the tables be performed at least in part during the switching method for another table. For example, in FIG. 3, bringing the table into the final position takes place simultaneously for the tables C and D, see step VIII. In addition, in the cases where the device is equipped with an actuator acting on the tables 4 from the accumulation surface 3 to make them slide along their edge opposite to the conveyor 11, the placing of a table in the final position can here again be carried out during the moving of another table 4.

The positioning of a new group of tables 4 to the right of the accumulation surface can take place before or after the transfer of the products that they carry.

As indicated previously, the movable tables 4 are configured to be able to be placed side by side, adjacent to an accumulation surface 3, so that the products can be transferred at the same time between the tables 4 and the accumulation surface 3. In other words, when tables 4 are placed side by side and adjacent to an accumulation surface 3, the products can be transferred, either from the accumulation surface 3 to the tables 4, or from the tables 4 to the accumulation surface 3.

Such a transfer can be performed using a transfer means that can in particular be a push means. Such a push is generally a horizontal push exerted in a direction perpendicular to the edge of the accumulation surface 3 that abuts the tables 4, in other words, a direction perpendicular to the direction in which the conveyor 11 extends.

Such a transfer means is then able to push products placed in the form of disjoint rows extending longitudinally, i.e., parallel to the edge of the accumulation surface 3 that abuts the tables 4 all while keeping the products aligned once they are transferred. The products can then advantageously be transported from a station 1 to another while maintaining their alignment.

Generally, the accumulation surface 3 is stationary and placed in the area of a station 1, either in the area of its input, or in the area of its output. An accumulation surface 3 placed in the area of the input of a station 1 is intended to receive products coming from movable tables 4. The products are then brought to the station 1 via a conveyor 11. An accumulation surface 3 placed in the area of the output of a station 1 is intended to receive products already processed by the station 1, by means of the conveyor 11. The products are then transferred to movable tables 4.

The transfer means used for the transfer of the products between an accumulation surface 3 and tables 4 generally belongs to the handling device 2 and is most often located in the area of the edge of the accumulation surface 3 that is opposite to the conveyor 11. Alternatively, each table 4 can be equipped with a transfer means.

As indicated previously, a translation of one or more tables along the accumulation surface 3 is possible by means of a translation means. The translation can in particular be performed by means of a shuttle, but other means can also be envisaged, using other means for driving in translation. Such embodiments prove particularly advantageous, particularly in terms of cost, because a smaller number of shuttles is then required, the approach and the departure of the tables 4 from the edge to and from the accumulation surface 3 being performed without necessitating a shuttle.

By way of example, a translation means can be attached to the accumulation surface 3 along the edge opposite to the conveyor 11. Such a translation means can in particular comprise a drive means that is mobile in longitudinal translation along the accumulation surface 3. It can, for example, be a belt wound around two pulleys, one motorized and the other driven. Such a belt can be provided with at least one pin that is capable of driving one or more tables 4 in translation. Of course, the pulley-and-belt system can be substituted by a chain-and-pinion system or by any other equivalent system.

Alternatively, the translation means can be made of two conveyors extending parallel to the conveyor 11, on the other side of the accumulation surface 3. These two conveyors are typically belt conveyors that are spaced from one another and sufficiently thin, so that one or more tables 4 can be moved by these two conveyors along the accumulation surface 3 and so that a shuttle can be placed under a table 4 and then be raised to relocate it. One conveyor is therefore placed near the accumulation surface, while the other is farther away from it. The conveying plane defined by these two conveyors is slightly lower than the accumulation surface 3. Its height is adjusted so that the receiving surface of a table 4 that is placed on these conveyors is flush with the accumulation surface 3 and thus facilitates the transfer of products. Such a system is advantageous to the extent that the height of the tables is particularly simple to adjust because the adjustment does not depend on the floor space.

When the translation means is made of two conveyors, the tables 4 are preferably simple plates, that is to say that they comprise neither feet nor wheels. The use of such plates instead of tables is particularly advantageous if it is necessary to store products, because such tables 4 can be easily placed in shelves one on top of the other, in order to save space.

Although the above description is based on particular embodiments, it is in no way limiting of the scope of the invention, and modifications can be made, particularly by substitution of technical equivalents or by a different combination of all or part of the characteristics developed above.

1. Device (2) for handling products between a workstation (1) and another station having an accumulation surface (3), comprising at least two movable tables (4), each equipped with a receiving surface (5), said at least two movable tables (4) being configured so as to be capable of being placed side by side, adjacent to said accumulation surface (3), so as to be able to transfer products at the same time between the at least two tables (4) and the accumulation surface (3).

2. Device (2) according to claim 1, in which said at least two movable tables (4) are configured to each be relocatable by an autonomous shuttle (6).

3. Device (2) according to claim 1, having a means for translating a table (4) along the accumulation surface (3).

4. Device (2) according to claim 3, in which said translation means is positioned integrally with the accumulation surface (3) and has a drive means that is movable along the accumulation surface.

5. Device (2) according to claim 4, having an open space for at least one table (4) upstream and/or downstream from said at least two tables (4).

6. Device (2) according to claim 1, having a means for coupling one table (4) to another.

7. Method for handling products between a workstation (1) and another station by means of a device according to claim 6, and having the following steps:
Transfer of products between said at least two tables (4) and the accumulation surface (3),
relocation of a first of said at least two tables (4),
then, relocation of a second of said at least two tables (4).

8. Method according to claim 7 having, before the relocation of the second of said at least two tables (4), the following additional step:
Depositing an additional table (4) in the extension of said at least two tables (4), so as to form with the latter an assembly similar to that of the first two tables (4).

9. Method according to claim 8, in which said additional step is performed after the relocation of the first table (4), so that no open space is used in the extension of said at least two tables (4).

10. Method according to claim 7, in which the relocation of the tables (4) is done by means of a single shuttle (6).

11. Method according to claim 7, in which simultaneous translations of tables (4) are done by translation of one table (4) pulling at least one other table (4).

12. Device (2) according to claim 2, having a means for translating a table (4) along the accumulation surface (3).

13. Device (2) according to claim 2, having a means for coupling one table (4) to another.

14. Device (2) according to claim 3, having a means for coupling one table (4) to another.

15. Device (2) according to claim 4, having a means for coupling one table (4) to another.

16. Device (2) according to claim 5, having a means for coupling one table (4) to another.

17. Method for handling products between a workstation (1) and another station by means of a device according to claim 1, and having the following steps:
Transfer of products between said at least two tables (4) and the accumulation surface (3),
relocation of a first of said at least two tables (4),
then, relocation of a second of said at least two tables (4).

18. Method for handling products between a workstation (1) and another station by means of a device according to claim 2, and having the following steps:
Transfer of products between said at least two tables (4) and the accumulation surface (3),
relocation of a first of said at least two tables (4),
then, relocation of a second of said at least two tables (4).

19. Method for handling products between a workstation (1) and another station by means of a device according to claim 3, and having the following steps:
Transfer of products between said at least two tables (4) and the accumulation surface (3),
relocation of a first of said at least two tables (4),
then, relocation of a second of said at least two tables (4).

20. Method for handling products between a workstation (1) and another station by means of a device according to claim 4, and having the following steps:
Transfer of products between said at least two tables (4) and the accumulation surface (3),
relocation of a first of said at least two tables (4),
then, relocation of a second of said at least two tables (4).
